(19) United States
(12) Patent Application Publication
(10) Pub. No.: US 2025/0327967 A1
(43) Pub. Date: Oct. 23, 2025

(54) HYBRID SINGLE MODE OPTICAL WAVEGUIDE

(71) Applicant: International Business Machines Corporation, Armonk, NY (US)

(72) Inventors: Akihiro Horibe, Yokohama (JP); Yoichi Taira, Tokyo (JP); CHINAMI ISHIKAWA, Yokohama-city (JP)

(21) Appl. No.: 18/639,425

(22) Filed: Apr. 18, 2024

(51) Int. Cl. G02B 6/02; G02B 1/04; G02B 6/036

(52) U.S. Cl. CPC G02B 6/02033; G02B 1/048; G02B 6/03638

(57) ABSTRACT

A hybrid single mode optical waveguide is provided that includes a glass core and a polymer clad or a polymer core and a glass clad substrate. Such hybrid single mode optical waveguides can provide both low optical loss and mechanical flexible (typically the case for the waveguide including the glass core and the polymer clad), or formation utilizing a simple fabrication process and compatibility with a photonic integrated circuit (typically the case for the waveguide including the polymer core on the glass clad substrate).

### BACKGROUND

The present application relates to an optical waveguide, and more particularly to a hybrid single mode optical waveguide.

An optical waveguide is a physical structure that guides electromagnetic waves in the optical spectrum. Common types of optical waveguides include optical fiber waveguides, transparent dielectric waveguides made of plastic, or glass light waveguides. Optical waveguides are typically used as a component in integrated optical circuits or as the transmission medium on local and long-haul optical communication systems. An optical waveguide can be classified according to its geometry (e.g., planar, strip or fiber waveguides), mode structure (e.g., single mode or multimode), refractive index distribution (step or gradient index) and material (e.g., glass, polymer or semiconductor).

An optical waveguide includes a core (i.e., a longitudinally extended high-index optical medium) surrounded by cladding (low-index media) in the transverse direction. The core guides optical waves along its longitudinal axis. The transverse profile of the dielectric constant determines the waveguide's characteristics.

### SUMMARY

A hybrid single mode optical waveguide is provided that includes a glass core and a polymer clad, or a polymer core and a glass clad substrate. Such hybrid single mode optical waveguides can provide both low optical loss and mechanical flexible (typically the case for the waveguide including the glass core and the polymer clad), or formation utilizing a simple fabrication process and compatibility with a photonic integrated circuit (typically the case for the waveguide including the polymer core on the glass clad substrate).

In one embodiment of the present application, a hybrid single mode optical waveguide is provided that includes a glass core having a first refractive index, and a polymer clad surrounding the glass core and having a second refractive index. In the present application, the first refractive index is greater than the second refractive index. Such a hybrid single mode optical waveguide can provide both low optical loss and mechanical flexible.

In another embodiment of the present application, a hybrid single mode optical waveguide is provided that includes a polymer core in direct physical contact with a glass clad substrate. Such a hybrid single mode optical waveguide is formed utilizing a simple fabrication process and it is compatible with a photonic integrated circuit.

### BRIEF DESCRIPTION OF THE DRAWINGS

FIG. 1A is a cross sectional view of a hybrid single mode optical waveguide in accordance with an embodiment of the present application.

FIG. 1B is a top down view of the hybrid single mode optical waveguide illustrated in FIG. 1A.

FIG. 2A is a cross sectional view of a hybrid single mode optical waveguide having structural uniformity enhancement in accordance with an embodiment of the present application.

FIG. 2B is a top down view of the hybrid single mode optical waveguide illustrated in FIG. 2A.

FIG. 3 is a cross sectional view of a hybrid single mode optical waveguide having low optical loss enhancement in accordance with an embodiment of the present application.

FIG. 4 is a cross sectional view of a hybrid single mode optical waveguide having low optical loss enhancement in accordance with an alternative embodiment of the present application.

FIG. 5 is a cross sectional view of a hybrid single mode optical waveguide having structural uniformity and low optical loss enhancement in accordance with an embodiment of the present application.

FIG. 6 is a cross sectional view of a hybrid single mode optical waveguide having structural uniformity and low optical loss enhancement in accordance with an alternative embodiment of the present application.

FIG. 7 is a cross sectional view of a hybrid single mode optical waveguide having structural uniformity and low optical loss enhancement in accordance with another alternative embodiment of the present application.

FIGS. 8A-8F are three dimensional (3D) illustrations of a basic processing flow that can be used in forming a hybrid single mode optical waveguide having a glass core and a polymer clad.

FIG. 9 is an illustration of a hybrid single mode optical waveguide including a polymer core and a glass clad substrate integrated with a photonic integrated circuit.

FIGS. 10A-10D illustrated various processing steps that can be used in the present application in fabricating a hybrid single mode waveguide with a polymer core and a glass clad substrate.

### DETAILED DESCRIPTION

The present application will now be described in greater detail by referring to the following discussion and drawings that accompany the present application. It is noted that the drawings of the present application are provided for illustrative purposes only and, as such, the drawings are not drawn to scale. It is also noted that like and corresponding elements are referred to by like reference numerals.

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

It will be understood that when an element as a layer, region or substrate is referred to as being “on” or “over” another element, it can be directly on the other element or intervening elements may also be present. In contrast, when an element is referred to as being “directly on” or “directly over” another element, there are no intervening elements present. It will also be understood that when an element is referred to as being “beneath” or “under” another element, it can be directly beneath or under the other element, or intervening elements may be present. In contrast, when an element is referred to as being “directly beneath” or “directly under” another element, there are no intervening elements present.

The terms substantially, substantially similar, about, or any other term denoting functionally equivalent similarities refer to instances in which the difference in length, height, or orientation convey no practical difference between the definite recitation (e.g., the phrase sans the substantially similar term), and the substantially similar variations. In one embodiment, substantial (and its derivatives) denote a difference by a generally accepted engineering or manufacturing tolerance for similar devices, up to, for example, 10% deviation in value or 10° deviation in angle.

Homogeneous optical waveguides including polymer optical waveguides and glass optical waveguides are known. Polymer optical waveguides include a polymer core and a polymer clad, whereas glass optical waveguides include a glass core and a glass clad. Polymer optical waveguides have mechanical flexibility and provide an easy co-packaged optical design. However, the optical loss of polymer waveguides is not very low (typically the optical loss of polymer waveguides is about 0.3 db/cm), and the length is limited by approximately 1 cm. Glass optical waveguides are not very flexible. An optical waveguide is needed that has low optical loss and is mechanical flexible. Also needed is an optical waveguide that is easy to fabricate and is compatible with a photonic integrated circuit.

The present application provides hybrid single mode optical waveguides including either a glass core and a polymer clad, or a polymer core and a glass clad substrate. The hybrid single mode optical waveguide including the glass core and the polymer clad can provide both low optical loss and mechanical flexible. The hybrid single mode optical waveguide including the polymer core and the glass clad substrate is easy to fabricate and is compatible with a photonic integrated circuit.

Throughout the present application, the term “single mode optical waveguide” denotes a waveguide designed to minimize modal dispersion. The single mode optical waveguide of the present application (whether including a glass core and polymer cladding, or a polymer core and a glass clad substrate) allows only one guided mode per polarization direction. The single mode optical waveguide of the present application achieves this by preventing the existence of higher-order waveguide modes. The single mode optical waveguide of the present application can be employed in various applications including, for example, integrated photonics, semiconductor lasers, and long-distance fiber-optic transmission.

In one embodiment, the single mode optical waveguide of the present application is a hybrid waveguide that includes a glass core and a polymer clad in which the refractive index of the glass core is greater than refractive index of the polymer clad. In another embodiment, the single mode optical waveguide of the present application is a hybrid waveguide that includes a polymer core and a glass clad substrate. Each of these hybrid single mode optical waveguides will now be described in greater detail.

### I. Hybrid Single Mode Optical Waveguide Including Glass Core and Polymer Clad

In this embodiment of the present application, a hybrid single mode optical waveguide is provided that includes a glass core having a first refractive index, and a polymer clad surrounding the glass core and having a second refractive index. In this embodiment of the present application, the first refractive index is greater than the second refractive index. In this embodiment in which a glass core and a polymer clad are employed, the hybrid single mode optical waveguide can provide both low optical loss and mechanical flexible.

In order to be mechanical flexible and for ease of handling for assembly, the hybrid single mode optical waveguide of this embodiment of the present application has a total thickness that is typically between 50 μm to 300 μm. The hybrid single mode optical waveguide of this embodiment of the present application has a length that is typically greater than 1 cm which is the limit of a polymer optical waveguide (POW).

Throughout the present application, the term “glass core” denotes a longitudinally extended high index optical medium that carriers a light signal. Throughout the present application, a single glass core can be used or a plurality of spaced apart glass cores can be used. The number of spaced apart glass cores that can be used can vary. In one example, ten or more glass cores can be used. The plurality of spaced apart glass cores can be arranged (i.e., oriented) along a same horizontal plane within the polymer clad, or they can be stacked over (in a vertical direction) each other. The glass core of the present application can have a height, as measured from a bottommost surface of the glass core to a topmost surface of the glass core, which is less than 5 μm, and a width, as measured from one sidewall of the glass core to the opposing sidewall of the glass core, which is less than 10 μm. Typically, the height of the glass core is from 0.5 μm to 4.5 μm, and the width of the glass core is from 1 μm to 9.5 μm. It is noted that the above height and width ranges for the glass core allow the optical waveguide to operate in a single mode condition.

Throughout the present application, the term “glass” denotes any non-crystalline (i.e., amorphous) solid that exhibits a glass transition (i.e., gradual and reversible transition in amorphous materials from a hard and relatively brittle “glassy” state into a viscous or rubbery state as the temperature is increased) when heated towards the liquid state. In the present application, the glass that is employed is composed mainly of silicon dioxide (i.e., the glass that is employed is a silicate glass). In the present application, the glass core has a first refractive index. The first refractive index of the glass core that can be used in the present application is typically from 1.4 to 2.4. The refractive index can be modified by the inclusion of a high-density additive (provides an increased refractive index) or low density additive (provides a reduced refractive index).

Throughout the present application, the term “polymer clad” denotes a low refractive index polymeric material that surrounds the glass core transversely. The polymer clad can also be referred to as a plastic clad. In the present application, the polymer clad has a second refractive index that is less than the first refractive index of the glass core. The polymer clad can be composed of a transparent polymeric material, a non-transparent polymeric material (including a low coefficient of thermal expansion (CTE) polymeric material as defined herein) or any combination thereof.

Throughout the present application, the term “transparent polymeric material” denotes a polymer that allows light to pass through it without substantial distortion or scattering. Transparent polymeric materials have a high degree of clarity, which means they allow visible or IR light to pass through almost unimpeded, and they do not absorb or scatter light significantly, making them suitable for applications where optical transparency is essential. In the present application, the transparent polymeric materials that can be used as the polymer clad typically have a refractive index from 1.3 to 1.6. Illustrative transparent polymeric materials that can be used in the present application include, but are not limited to, polymethyl methacrylate (PMMA) or polycarbonate (PC) for visible light, and per-fluorinated polymers for IR region. The use of transparent polymeric materials can eliminate optical loss of evanescent light.

Throughout the present application, the term “non-transparent polymeric material” denotes a polymer that does not transmit a substantial amount (typically less than 90%) of light therethrough. In the present application, the non-transparent polymeric materials that can be used as the polymer clad typically have a CTE of less than 50 ppm. Non-transparent polymeric materials that have a CTE of less than 50 ppm can be referred to as low CTE polymeric materials. Illustrative non-transparent polymeric materials that can be used in the present application include, but are not limited to, inorganic filler contained polymers or crystalline polymers. The use of non-transparent polymeric materials can reduce CTE mismatch with photonic IC and transmission cross talk.

Throughout the present application, the term “glass clad” denotes a cladding layer(s) of glass that can be positioned between the glass core and the polymer clad. The glass clad can be used to reduce optical loss of evanescent light. The glass clad can have a third refractive index that can be less than the first refractive index. Glass clad embodiments include (i) a sandwiching glass clad in which the glass core is located between a first glass clad and a second glass clad, (ii) an encasing glass clad that surrounds an entirety of the glass core, or (iii) a glass clad layer that surrounds the glass core and separates a first polymer layer of the polymer clad from a second polymer layer of the polymer clad. Glass clad embodiments (i) and (ii) provide low optical loss enhancement to the hybrid single mode waveguide of the present application, while glass clad embodiment (iii) provides both low optical loss and structural uniformity enhancements. When present, the glass clad can have a thickness of less than 5 μm, with a thickness from 0.5 μm to 4.0 μm being more typical for the glass clad.

Throughout the present application, the term “non-functional glass structure” denotes a glass structure that is present in the hybrid single mode optical waveguide of the present application in which the glass structure is not configured to carrier a light signal; i.e., it is not operable as a light carrier. The non-functional glass structure can be located adjacent to, and spaced apart from, the glass core, and it is embedded in the polymer clad. In some embodiments, non-functional glass structures are present throughout the entire waveguide area. The non-functional glass structure(s) is (are) used to maintain structural uniformity in the hybrid single mode optical waveguide of the present application.

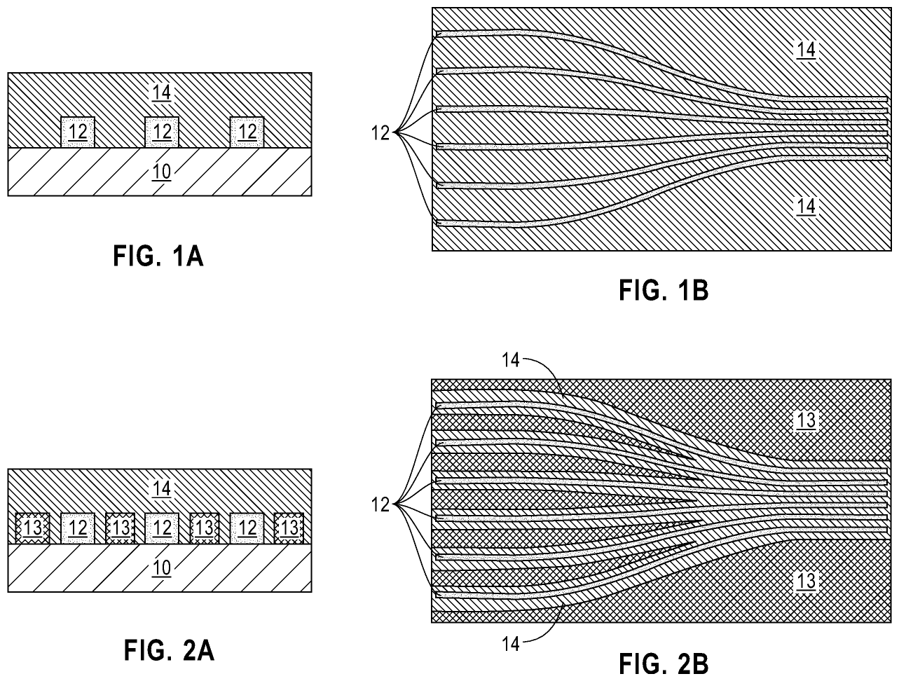

The hybrid single mode optical waveguide of this embodiment of the present application will now be described in greater detail by referring to FIGS. 1A-7 which illustrate various hybrid single mode optical waveguides that include a glass core 12 and a polymer clad, both as defined above. The polymer clad surrounds (i.e., embeds) the glass core 12. In the various embodiments illustrated in FIGS. 1A-5, the polymer clad includes a first polymer layer 10 and a second polymer layer 14. In FIGS. 6-7, the polymer clad is shown as a low CTE polymer clad 24.

Referring first to FIGS. 1A-1B, there are illustrated a hybrid single mode optical waveguide in accordance with an embodiment of the present application. The hybrid single mode optical waveguide illustrated in FIGS. 1A-1B includes a plurality of spaced apart glass cores 12 (each glass core 12 having the first refractive index mentioned above) that are arranged within a same horizontal plane in the polymer clad. In the embodiment illustrated in FIGS. 1A-1B, each glass core 12 is located on a surface of the first polymer layer 10 and each glass core 12 is embedded in the second polymer layer 14. Collectively, the first polymer layer 10 and the second polymer layer 14 provide the polymer clad of this embodiment of the present application. Also, and in the illustrated embodiment of FIGS. 1A-1B, the polymer clad is in direct physical contact with each glass core 12. Notably, the second polymer layer 14 forms a material interface with a sidewall and a topmost surface of each glass core 12, while the first polymer layer 10 forms a material interface with a bottommost surface of each glass core 12.

In some embodiments of the present application, the first polymer layer 10 and the second polymer layer 14 are both composed of a transparent polymeric material, as defined above. The transparent polymeric material that provides the first polymer layer 10 can be compositionally the same as, or compositionally different from, the transparent polymeric material that provides the second polymer layer 14. In other embodiments of the present application, the first polymer layer 10 and the second polymer layer 14 are both composed of a non-transparent polymeric material. The non-transparent polymeric material that provides the first polymer layer 10 can be compositionally the same as, or compositionally different from, the non-transparent polymeric material that provides the second polymer layer 14. In yet another embodiment of the present application, the first polymer layer 10 and the second polymer layer can be composed of a low CTE polymeric material, as defined above. The low CTE polymeric material is a type of non-transparent polymeric material. The low CTE polymeric material that provides the first polymer layer 10 can be compositionally the same as, or compositionally different from, the low CTE material that provides the second polymer layer 14. Typically, when different low CTE materials are used, the CTE of each of the low CTE materials are substantially the same (i.e., within 10% of each other).

In yet a further embodiment the first polymer layer 10 is composed of a transparent polymeric material, while the second polymer layer 14 is composed of a non-transparent polymeric material. In yet another embodiment of the present application, the first polymer layer 10 is composed of a non-transparent polymeric material, while the second polymer layer 14 is composed of a transparent polymeric material. In an even further embodiment, one of the first polymer layer 10 or the second polymer layer 14 is composed of a low CTE polymeric material, while the polymer layer of the polymer clad not including the low CTE material is composed of a transparent polymeric material or a non-transparent material. In such embodiments, the low CTE material and the transparent polymeric material or the non-transparent material have CTEs that are within 10% of each other.

Referring now to FIGS. 2A-2B, there are illustrated a hybrid single mode optical waveguide having structural uniformity enhancement in accordance with an embodiment of the present application. The hybrid single mode optical waveguide illustrated in FIGS. 2A-2B is essentially the same as the hybrid single mode optical waveguide illustrated in FIGS. 1A-1B in that it includes a plurality of spaced apart glass cores 12 (arranged along a same horizontal plane in the polymer clad) and a polymer clad including a first polymer layer 10 and a second polymer layer 14. In the embodiment illustrated in FIGS. 2A-2B, each glass core 12 is located on a surface of the first polymer layer 10 and each glass core 12 is embedded in the second polymer layer 14. Also, and in the illustrated embodiment of FIGS. 2A-2B, the polymer clad is in direct physical contact with each glass core 12. Notably, the second polymer layer 14 forms a material interface with a sidewall and a topmost surface of each glass core 12, while the first polymer layer 10 forms a material interface with a bottommost surface of each glass core 12. The hybrid single mode optical waveguide illustrated in FIGS. 2A-2B differs from the hybrid single mode optical waveguide illustrated in FIGS. 1A-1B in that the hybrid single mode optical waveguide illustrated in FIGS. 2A-2B includes non-functional glass structures 13, as defined above. In the illustrated embodiment of FIGS. 2A-2B, each non-functional glass structures 13 is located adjacent to, and between, each of the glass cores 12. As is illustrated, the non-functional glass structures 13 are located in the same horizontal plane as the glass cores 12. Each non-functional glass structures 13 is located on a surface of the first polymer layer 10 and non-functional glass structures 13 is embedded in the second polymer layer 14. Also, and in the illustrated embodiment of FIGS. 2A-2B, the polymer clad is in direct physical contact with non-functional glass structures 13. Notably, the second polymer layer 14 forms a material interface with a sidewall and a topmost surface of each non-functional glass structure 13, while the first polymer layer 10 forms a material interface with a bottommost surface of each non-functional glass structure 13. In this embodiment, the non-functional glass structures 13 provide structural uniformity enhancement to the waveguide as compared to the waveguide illustrated in FIGS. 1A-1B.

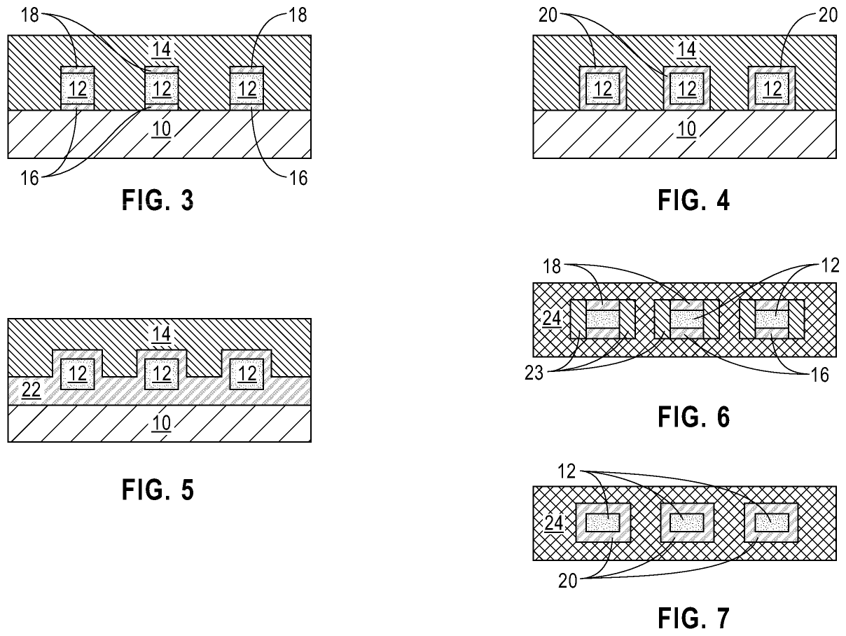

Referring now to FIG. 3, there is illustrated a hybrid single mode optical waveguide having low optical loss enhancement in accordance with an embodiment of the present application. The hybrid single mode optical waveguide illustrated in FIG. 3 is essentially the same as the hybrid single mode optical waveguide illustrated in FIGS. 1A-1B in that it includes a plurality of spaced apart glass cores 12 (arranged along a same horizontal plane in the polymer clad) and a polymer clad including a first polymer layer 10 and a second polymer layer 14. The hybrid single mode optical waveguide illustrated in FIG. 3 differs from the hybrid single mode optical waveguide illustrated in FIGS. 1A-1B in that each glass core 12 is sandwiched between a first glass clad 16 and a second glass clad 18. The first glass clad 16 and the second glass clad 18 are individual cladding layers that are embedded in the second polymer layer 14 and impart low optical loss improvement to the waveguide. In the illustrated embodiment of FIG. 3, the first glass clad 16 forms a first material interface with the first polymer layer 10, and a second material interface, which is opposite to the first material interface, with the glass clad 12. The second glass clad 18 forms a material interface with the glass clad 12. In the illustrated embodiment, the first glass clad 16 has sidewalls that are vertically aligned to the sidewalls of both the glass core 12 and the second glass clad 18. In this embodiment, sidewalls of each glass core 12 are in direct contact with the second polymer layer 14.

Referring now to FIG. 4, there is illustrated a hybrid single mode optical waveguide having low optical loss enhancement in accordance with an alternative embodiment of the present application. The hybrid single mode optical waveguide illustrated in FIG. 4 is essentially the same as the hybrid single mode optical waveguide illustrated in FIGS. 1A-1B in that it includes a plurality of spaced apart glass cores 12 (arranged along a same horizontal plane in the polymer clad) and a polymer clad including a first polymer layer 10 and a second polymer layer 14. The hybrid single mode optical waveguide illustrated in FIG. 4 differs from the hybrid single mode optical waveguide illustrated in FIGS. 1A-1B in that each glass core 12 is surrounded by an encasing glass clad 20. Encasing glass clad 20 is ring shaped, and is embedded in the second polymer layer 14. In this embodiment, each glass core 12 is surrounded by an inner cladding, i.e., encasing glass clad 20, and the inner cladding, i.e., encasing glass clad 20, is surrounded by the polymer clad. The encasing glass clad 20 imparts low optical loss improvement to the waveguide.

Referring now to FIG. 5, there is illustrated a hybrid single mode optical waveguide having structural uniformity and low optical loss enhancement in accordance with an embodiment of the present application. The hybrid single mode optical waveguide illustrated in FIG. 5 is essentially the same as the hybrid single mode optical waveguide illustrated in FIGS. 1A-1B in that it includes a plurality of spaced apart glass cores 12 (arranged along a same horizontal plane in the polymer clad) and a polymer clad including a first polymer layer 10 and a second polymer layer 14. The hybrid single mode optical waveguide illustrated in FIG. 5 differs from the hybrid single mode optical waveguide illustrated in FIGS. 1A-1B in that glass clad layer 22 is present. The glass clad layer 22 surrounds each glass core 12 and is located between each glass core 12 and the polymer clad. The glass clad layer 22 has a horizontal portion that separates the first polymer layer 10 of the polymer clad from the second polymer layer 14 of the polymer clad. The glass clad layer 22 imparts both low optical loss improvement and structural uniformity improvement to the waveguide.

It is noted that in any of the embodiments shown in FIGS. 3, 4 and 5 (or in FIGS. 6 and 7 to follow), the non-functional glass structures 13 can be present to further enhance structural uniformity in those hybrid single mode optical waveguides.

Referring now to FIG. 6, there is illustrated a hybrid single mode optical waveguide having structural uniformity and low optical loss enhancement in accordance with an alternative embodiment of the present application. In this embodiment, the hybrid single mode optical waveguide includes glass cores 12 that are sandwiched between first glass clad 16 and second glass clad 18, an inner polymer clad 23 is located on each of the sidewalls of each glass core 12, and a low CTE polymer clad 24 surrounds each of the glass cores 12; the low CTE polymer clad 24 forms an outer polymer clad for this embodiment of the present application. Although not illustrated the low CTE polymer clad 24 would include a first low CTE polymer layer and a second low CTE polymer layer. In this embodiment, inner polymer clad 23 is composed of a transparent polymeric material or a non-transparent material, both as defined above, and the low CTE polymer clad 24 is composed of at least one of the low CTE polymeric materials, as defined above. The glass cores 12, first glass clad 16 and second glass clad 18 are the same as described above.

Referring now to FIG. 7, there is illustrated a hybrid single mode optical waveguide having structural uniformity and low optical loss enhancement in accordance with another alternative embodiment of the present application. In this embodiment, the hybrid single mode optical waveguide includes glass cores 12 that are surrounded by the encasing glass clad 20. Although not illustrated the low CTE polymer clad 24 would include a first low CTE polymer layer and a second low CTE polymer layer. In this embodiment, the low CTE polymer clad 24 is composed of at least one of the low CTE polymeric materials, as defined above. The glass cores 12 and the encasing glass clad 20 are the same as described above.

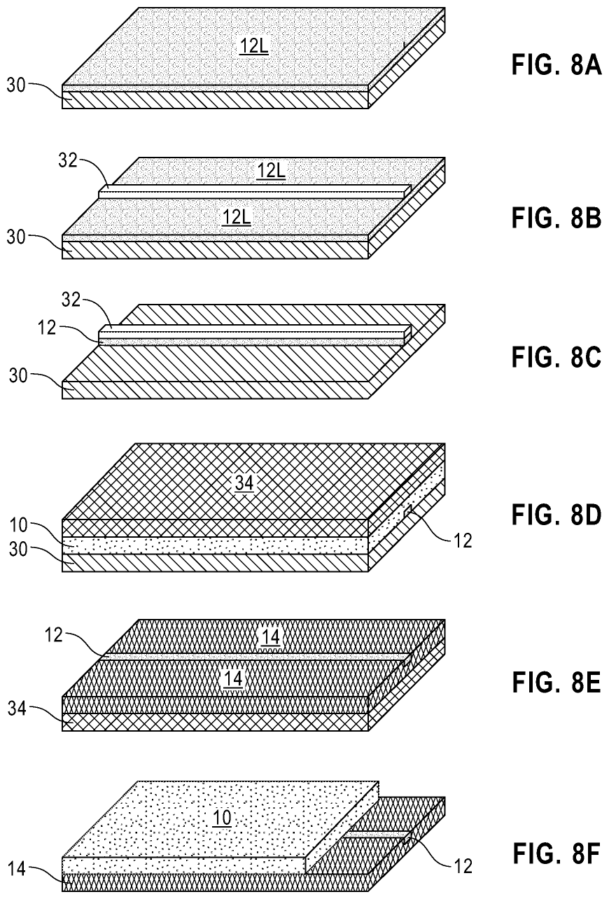

Referring now to FIGS. 8A-8F, there are provided 3D illustrations of a basic processing flow that can be used in forming a hybrid single mode optical waveguide having a glass core and a polymer clad; the processing flow provides the hybrid single mode optical waveguide shown in FIGS. 1A-1B and with modifications describe herein this processing flow can be used to provide the hybrid single mode optical waveguides illustrated in FIGS. 2A-7. The process flow begins by providing a glass layer 12L on a surface of a substrate 30 to provide the exemplary structure illustrated in FIG. 8A. Substrate 30 is typically composed of a semiconductor material such as, for example, silicon (Si). The glass layer 12L can be formed on the substrate 30 utilizing a deposition process such as, for example, chemical vapor deposition (CVD), plasma enhanced chemical vapor deposition (PECVD), or physical vapor deposition (PVD). Next, and as is shown in FIG. 8B, a patterned photoresist 32 is formed on a surface of the glass layer 12L. The patterned photoresist 32 can be formed by depositing (e.g., CVD, PECVD or spin-on coating) a photoresist material on the glass layer 12L, exposing the as-deposited photoresist material to a desired pattern of irradiation, and developing the exposed photoresist material. Although a single patterned photoresist 32 is described and illustrated, a plurality of patterned photoresists 32 can be formed on the glass layer 12L. When a plurality of patterned photoresists are formed that are typically oriented parallel to each other. Next, and as illustrated in FIG. 8C, an etch is used to transfer the patterned provided by the patterned photoresist 32 into the underlying glass layer 12L and to provide glass core 12. A plurality of glass cores 12 can be formed when a plurality of patterned photoresist 32 are present. Also, and when a plurality of patterned photoresists 32 are present, some of non-etched portions of the glass layer 12L can be used in providing the non-functional glass structures 13. The etch can include a dry etching process or a wet etching process. Drying etching can include, for example, reactive ion etching (RIE), laser etching, or plasma etching. Wet etching includes the use of a chemical etchant. Next, and as is shown in FIG. 8D, the patterned photoresist 32 is removed and thereafter second polymer layer 14 is formed, followed by forming a handler substrate 34 on the second polymer layer 14. The removal of the patterned photoresist 32 includes the use of any photoresist material removal process. The second polymer layer 14 can be formed by a deposition process including, for example, CVD, PECVD, or spin-on coating. Note that the second polymer layer 14 is formed along the sidewalls of the glass core 12 and on a physically exposed horizontal surface of the glass core 12. The handle substrate 34 can include another semiconductor material or a dielectric material. The handler substrate 34 can be formed on the second polymer layer 14 by a bonding process or by a deposition process, followed typically, but necessarily always, by a planarization process such as, for example, griding or chemical mechanical polishing (CMP). The exemplary structure illustrated in FIG. 8D is then flipped 180 degrees, and thereafter the substrate 30 can be removed utilizing a material removal process, such as, for example, mechanical debonding, grinding, or CMP, which is selective in removing substrate 30 providing the exemplary structure illustrated in FIG. 8E. Next, and as show in FIG. 8F, first polymer layer 10 is formed on physically exposed portions of both the glass core 12 and the second polymer layer 14. The first polymer layer 10 can be formed by a deposition process including, for example, CVD, PECVD, or spin-on coating. After forming the first polymer layer 10, the handler substrate 34 can be removed utilizing any removal process that is selective in removing the handler substrate 34 from the structure (the removal of the handler substrate 34 can be before or after a subsequently performed flipping step). The structure illustrated in FIG. 8F is then flipped 180 degrees such that the first polymer layer 10 is located beneath both the glass core 12 and the second polymer layer 14. Note that in FIG. 8F, the first polymer layer 10 is intentionally shown as not covering the entirety of the second polymer layer 14, is an adiabatic coupling area bonding to photonic IC.

Vertically stacked glass cores 12 can be formed by depositing a low refractive index dielectric on the first level of glass cores, then planarize if needed, and repeat the processing illustrated in FIGS. 8A-8C.

In embodiments in which the first glass clad 16 and the second glass clad 18 are present, the process flow mentioned above can be modified by substituting the structure shown in FIG. 8A with one including, from bottom to top, substrate 30, a first glass clad layer (not shown), glass layer 12L and a second glass clad layer (not shown). The first glass clad layer, glass layer 12L, second glass clad layer can be formed utilizing a same deposition process or different deposition processes can be used. Deposition can include, for example, CVD, PECVD, PVD or any combination thereof. In this embodiment, the first glass clad layer and the second clad layer have the third refractive index as mentioned above. After forming the first glass clad layer (not shown), glass layer 12L and the second glass clad layer (not shown) on the substate 30, the process continues as shown in the FIGS. 8B-8F. During the etch, the first glass clad layer and the second glass clad layer are patterned into the first glass clad 16 and the second glass clad 18, respectively. The inclusion of the first glass clad layer and the second glass clad layer into the processing flow provides a hybrid single mode waveguide as illustrated in FIG. 3.

In embodiments in which glass clad layer 22 or encasing glass clad 20 is present, the process flow mentioned above can be modified by substituting the structure shown in FIG. 8A with one including, from bottom to top, substrate 30, the first glass clad layer (not shown), glass layer 12L and the second glass clad layer (not shown). After forming the first glass clad layer (not shown), glass layer 12L and the second glass clad layer (not shown) on the substate 30, the process continues as shown in the FIGS. 8B-8C. During the etch, the first glass clad layer and the second glass clad layer are patterned into a lower glass clad layer and an upper glass clad layer, respectively. Next, and before proceeding to the processing shown in FIGS. 8D-8F, a glass clad liner (not shown) is formed along the physically exposed surface of the substrate 30 and along the sidewalls and a topmost surface of the patterned structure including the lower clad layer, the glass core 12, and the upper glass clad layer. The combination of the glass clad liner, the lower clad layer and the upper clad layer provides glass clad layer 22. The processing shown in FIGS. 8D-8F can then be performed to provide the hybrid single mode waveguide as illustrated in FIG. 5. Alternatively, the glass clad layer 22 can be etched to remove portions of the glass clad layer 22 that are present on top of the substrate 30 resulting in encasing glass clad 20 surrounding the glass core 12. The processing shown in FIGS. 8D-8F can then be performed to provide the hybrid single mode waveguide as illustrated in FIG. 5.

In embodiments in which the hybrid single mode waveguide as illustrated in FIG. 7 is formed, the processing that provides encasing glass clad 20 surrounding the glass core 12 described above can be modified by using low CTE polymeric materials as the first polymer layer 10 the second polymer layer 14.

In embodiments in which the hybrid single mode waveguide as illustrated in FIG. 6 is formed, the process flow includes forming a first glass clad layer glass layer 12L and a second glass clad layer on a surface of a low CTE polymer. Lithography and etching can then be used to pattern the first glass clad layer glass layer 12L and second glass clad layer into a patterned structure of the first clad 16, glass core 12, and second clad 18. A layer of a transparent polymeric material or a layer of a non-transparent polymeric material is then formed on top of, and adjacent to, the patterned structure. Lithography and etching can then be used to the layer of transparent polymeric material or the layer of a non-transparent polymeric material into inner polymer clad 23. Another low CTE polymer is then formed providing the hybrid single mode waveguide as illustrated in FIG. 6.

In this embodiment of the present application (hereafter “glass core/polymer clad embodiment”, a hybrid single mode optical waveguide is provided (see, for example, FIGS. 1A-7) that includes glass core 12 having a first refractive index, and a polymer clad surrounding the glass core 12 and having a second refractive index. In the present application, the first refractive index is greater than the second refractive index. Such a hybrid single mode optical waveguides can provide both low optical loss and mechanical flexible.

In the glass core/polymer clad embodiment, the polymer clad includes first polymer layer 10 and second polymer layer 14 as is shown in FIGS. 1A-5. In FIGS. 6-7, the first polymer layer 10 and the second polymer layer 14 are not shown but are meant to be included within the region disclosed herein as low CTE polymer clad 24.

In some embodiments of the glass core/polymer clad embodiment, the first polymer layer 10 and the second polymer layer 14 are in direct physical contact with the glass core 12. Such embodiments are shown, for example, in FIGS. 1A-3.

In the glass core/polymer clad embodiment, the first polymer layer 10 and the second polymer layer 14 are composed of a transparent polymeric material used as a core-surrounded optical clad for eliminating evanescent light loss, and a non-transparent polymeric material (preferably a low CTE polymeric material) used for a far-clad for mechanical reinforcement or any combination thereof.

In the glass core/polymer clad embodiment, the first polymer layer 10 and the second polymer layer 14 are composed of a same polymeric material selected from a transparent polymeric material and a non-transparent polymeric material (including low CTE polymeric materials).

In some embodiments of the glass core/polymer clad embodiment (see, for example FIGS. 2A-2B), non-functional glass structure 13 is present and is located adjacent to, and spaced apart from, the glass core 12. As is shown, the non-functional glass structure 13 is embedded in the polymer clad (i.e., the second polymer layer 14 that provides an upper portion of the polymer clad). The presence of the non-functional glass structure 13 provides structural uniformity enhancement to the waveguide.

In some embodiments of the glass core/polymer clad embodiment (see, for example FIG. 3), the glass core 12 is sandwiched between a first glass clad 16 and a second glass clad 14. The presence of the first glass clad 16 and the second glass clad 14 provides low optical loss enhancement to the waveguide.

In such embodiments in which the first glass clad 16 and the second glass clad 14 are present, the first glass clad 16 and the second glass clad 18 have a third refractive index, and the third index and the second index are less than the first refractive index. This aspect achieves the low optical loss mentioned above.

In some embodiments of the glass core/polymer clad embodiment (see, for example FIG. 4), encasing glass clad 20 is present surrounding the glass core 12 and located between the glass core 12 and the polymer clad. The presence of the encasing glass clad 20 provides low optical loss enhancement to the waveguide.

In such embodiments in which the encasing glass clad 20 is present, the encasing glass clad 20 has a third refractive index, and the third index is less than the first refractive index. This aspect achieves the low optical loss mentioned above.

In some embodiments of the glass core/polymer clad embodiment (see, for example FIG. 5), glass clad layer 22 is present surrounding the glass core 12 and located between the glass core 12 and the polymer clad. Notably, the glass clad layer 22 separates the first polymer layer 10 of the polymer clad from the second polymer layer 14 of the polymer clad. The presence of the glass clad layer 22 provides low optical loss enhancement and structural enhancement to the waveguide.

In such embodiments in which the glass clad layer 22 is present, the glass clad layer 22 has a third refractive index, and the third index is less than the first refractive index. This aspect achieves the low optical loss mentioned above.

In some embodiments of the glass core/polymer clad embodiment (see, for example FIGS. 1A-7. the glass core 12 includes a plurality of spaced apart glass cores that are arranged within a same horizontal plane in the polymer clad.

In some embodiments of the glass core/polymer clad embodiment (not shown by readily derivable from FIGS. 1A-7, the glass core 12 includes a plurality of spaced apart glass cores that are stacked over each other.

In the glass core/polymer clad embodiment, the glass core 12 has a height that is less than 5 μm, and a width, which is less than 10 μm. These ranges ensure that waveguide operates as a single mode waveguide.

In the glass core/polymer clad embodiment, the waveguide has a total thickness of from 50 μm to 300 μm, and a length of greater than 1 cm. These ranges ensure that waveguide operates as a single mode waveguide.

### II. Hybrid Single Mode Optical Waveguide Including Polymer Core and Glass Clad Substrate

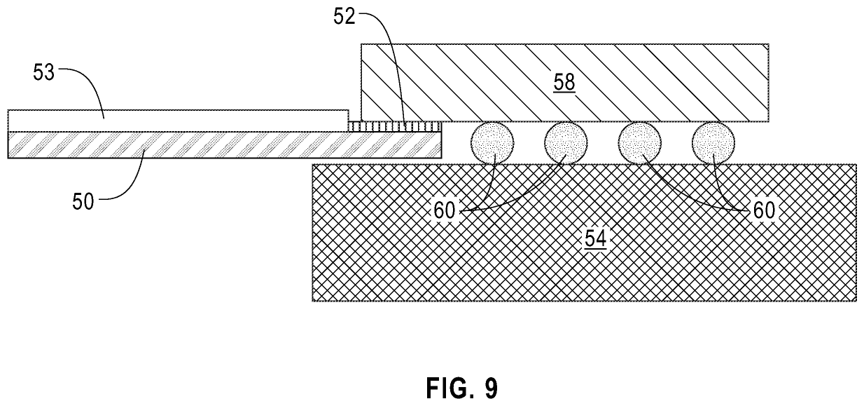

In another embodiment of the present application, a hybrid single mode optical waveguide is provided that includes a polymer core in direct physical contact with a glass clad substrate. Such a hybrid single mode optical waveguide is formed utilizing a simple fabrication process and it is compatible with a photonic integrated circuit. This embodiment of the present application will be described in respect to FIG. 9 which provides an illustration of a hybrid single mode optical waveguide (polymer core/glass clad substrate) integrated with a photonic integrated circuit. Notably, FIG. 9 illustrates a hybrid single mode optical waveguide including polymer core 52 in direct physical contact with glass clad substrate 50. FIG. 9 also includes a polymer clad 53 which is located on a portion of the polymer core 52, a photonic integrated circuit 58 attached to an organic substrate (or package) 54 by means of solder balls 60.

Throughout the present application, the term “photonic integrated circuit” denotes a microchip containing two or more photonic components that form a functioning circuit. This technology detects, generates, transports, and processes light. Photonic integrated circuits utilize photons (or particles of light) as opposed to electrons that are utilized by electronic integrated circuits. The major difference between the two is that a photonic integrated circuit provides functions for information signals imposed on optical wavelengths typically in the visible spectrum or near infrared (850 nm-1650 nm).

The organic substrate 54 is composed of well-known organic materials that are typically used in photonics and/or semiconductor packaging technologies. Solder balls 60 are composed of lead free or lead containing solder, each of which is well known in the art.

Glass clad substrate 50 that can be employed includes glass as defined above. Notably, the glass clad substrate 50 that is employed is composed mainly of silicon dioxide (i.e., the glass that is employed is a silicate glass). In the present application, the glass clad substrate 50 has a refractive index from 1.3 to 1.6. The refractive index can be modified by the inclusion of a high-density additive (provides an increased refractive index) or low density additive (provides a reduced refractive index).

The polymer core 52 includes a polymeric material having a refractive index of from 1.4 to 1.7. The polymer core 52 is typically composed of a halogenated polymer, with fluorinated polymers such as, for example, fluorinated polyimide, a fluorinated vinyl ether polymer or fluorinated polybenzoxazole being preferred in some embodiments over other halogenated polymers.

The polymer clad 53 includes z transparent polymeric material or a non-transparent material (including a low CTE polymeric material) as defined above for the previous embodiment of the present application.

The hybrid single mode optical waveguide including polymer core 52 and glass clad substrate 50 is a reflow resistant optical waveguide for CPO (Co-package optics) module. The hybrid single mode optical waveguide including polymer core 52 and glass clad substrate 50 has adiabatic coupling with strong adhesion, low CTE mismatch with the photonic integrated circuit 58, can be made by a bonding process.

In this embodiment (hereinafter “polymer core/glass clad substrate embodiment”, a hybrid single mode optical waveguide (such as, shown in FIG. 9) is provided that includes polymer core 52 in direct physical contact with glass clad substrate 50. Such a hybrid single mode optical waveguide is formed utilizing a simple fabrication process and it is compatible with a photonic integrated circuit.

In the polymer core/glass clad substrate embodiment, the polymer core includes a polymeric material having a refractive index of from 1.4 to 1.7.

In the polymer core/glass clad substrate embodiment, the polymeric material includes a halogenated polymer with a soluble refractive-index-control additive/dopant.

In the polymer core/glass clad substrate embodiment, the halogenated polymer is a fluorinated polymer with a soluble refractive-index-control additive/dopant.

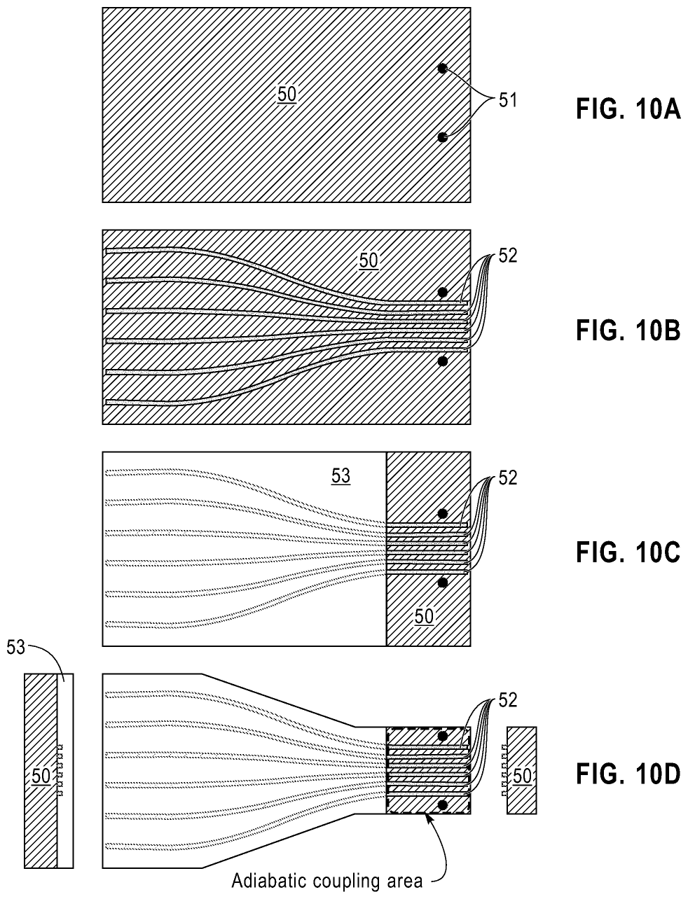

Referring now to FIGS. 10A-10D, there are various processing steps that can be used in the present application in fabricating a hybrid single mode waveguide with a polymer core 52 and a glass clad substrate 50. Notably, FIG. 10A shows a glass plate that is used as the glass clad substrate 50 that includes alignment marks 51 for bonding to a photonic integrated circuit. The alignment marks 51 can be formed by lithography and PVD or plating process. FIG. 10B shows polymer cores 52 being formed on the glass clad substrate illustrated in FIG. 10A. The polymer cores 52 can be formed by deposition of a polymeric material, followed by lithographic patterning. FIG. 10C shows a polymer clad 53 being formed on a portion of the polymer cores 52 illustrated in FIG. 10B. The polymer clad 53 can be formed by deposition of a polymeric material, followed by lithographic patterning. FIG. 10D shows the hybrid optical waveguide after dicing. (Note: FIGS. 10A-10C show a part of a larger size panel or wafer. These may not be rectangle shape shown there.)

While the present application has been particularly shown and described with respect to preferred embodiments thereof, it will be understood by those skilled in the art that the foregoing and other changes in forms and details may be made without departing from the spirit and scope of the present application. It is therefore intended that the present application not be limited to the exact forms and details described and illustrated, but fall within the scope of the appended claims.

What is claimed is:

1. A hybrid single mode optical waveguide comprising:
a glass core having a first refractive index; and
a polymer clad surrounding the glass core and having a second refractive index, wherein the first refractive index is greater than the second refractive index.

2. The hybrid single mode optical waveguide of claim 1, wherein the polymer clad comprises a first polymer layer and a second polymer layer.

3. The hybrid single mode optical waveguide of claim 2, wherein the first polymer layer and the second polymer layer are in direct physical contact with the glass core.

4. The hybrid single mode optical waveguide of claim 2, wherein the first polymer layer and the second polymer layer are composed of a transparent polymeric material, a non-transparent polymeric material or any combination thereof.

5. The hybrid single mode optical waveguide of claim 2, wherein the first polymer layer and the second polymer layer are composed of a same polymeric material selected from a transparent polymeric material and a non-transparent polymeric material.

6. The hybrid single mode optical waveguide of claim 1, further comprising a non-functional glass structure located adjacent to, and spaced apart from, the glass core, wherein the non-functional glass structure is embedded in the polymer clad.

7. The hybrid single mode optical waveguide of claim 1, wherein the glass core is sandwiched between a first glass clad and a second glass clad.

8. The hybrid single mode optical waveguide of claim 7, wherein the first glass clad and the second glass clad have a third refractive index, and the third refractive index is less than the first refractive index.

9. The hybrid single mode optical waveguide of claim 1, further comprising an encasing glass clad surrounding the glass core and located between the glass core and the polymer clad.

10. The hybrid single mode optical waveguide of claim 9, wherein the encasing glass clad has a third refractive index, and the third index is less than the first refractive index.

11. The hybrid single mode optical waveguide of claim 1, further comprising a glass clad layer surrounding the glass core and located between the glass core and the polymer clad, wherein the glass clad layer separates a first polymer layer of the polymer clad from a second polymer layer of the polymer clad.

12. The hybrid single mode optical waveguide of claim 11, wherein the glass clad layer has a third refractive index, and the third refractive index is less than the first refractive index.

13. The hybrid single mode optical waveguide of claim 1, wherein the glass core comprises a plurality of spaced apart glass cores that are arranged within a same horizontal plane in the polymer clad.

14. The hybrid single mode optical waveguide of claim 1, wherein the glass core comprises a plurality of spaced apart glass cores that are stacked over each other.

15. The hybrid single mode optical waveguide of claim 1, wherein the glass core has a height that is less than 5 μm, and a width, which is less than 10 μm.

16. The hybrid single mode optical waveguide of claim 1, wherein the waveguide has a total thickness of from 50 μm to 300 μm, and a length of greater than 1 cm.

17. A hybrid single mode optical waveguide comprising:
a polymer core in direct physical contact with a glass clad substrate.

18. The hybrid single mode optical waveguide of claim 17, wherein the polymer core comprises a polymeric material having a refractive index of from 1.4 to 1.7.

19. The hybrid single mode optical waveguide of claim 18, wherein the polymeric material comprises a halogenated polymer.

20. The hybrid single mode optical waveguide of claim 17, further comprising a polymer clad located on a portion of the polymer core.
